(19) United States
(12) Patent Application Publication
(10) Pub. No.: US 2016/0296937 A1
(43) Pub. Date: Oct. 13, 2016

(54) SEALED CONTAINER, AND SEALED-CONTAINER SET

(71) Applicant: ENPLAS CORPORATION, Saitama (JP)

(72) Inventors: Koichi ONO, Saitama (JP); Tomoki NAKAO, Saitama (JP); Shota TAKAMATSU, Saitama (JP)

(21) Appl. No.: 15/037,079

(22) PCT Filed: Nov. 5, 2014
(86) PCT No.: PCT/JP2014/079366

§ 371 Date: May 17, 2016

(30) Foreign Application Priority Data
Nov. 20, 2013 (JP) 2013-239764

(51) Int. Cl. B01L 9/00; B65D 51/00; B65D 77/20; B01L 3/00

(52) U.S. Cl. CPC B01L 9/543; B01L 3/523; B65D 51/002; B65D 77/2028; B01L 2200/141; B01L 2300/123; B01L 2300/044; B01L 2200/142; B01L 2300/0829

(57) ABSTRACT

This sealed container (200) is provided with: a multi-chamber container (210) provided with eight containers (2100) arranged in an X direction; and an integral film (220) which seals openings (211) of all of the eight containers (2100). A tip (230) is accommodated in each of the containers (2100). The film (220) seals the openings (211) using sections including first folding lids and second folding lids which are capable of being folded towards sides of the containers (2100) by being pressed from an exterior. A sealed-container set (100) is configured by causing a plurality of the sealed containers (200) to engage with a support frame (300).

### TECHNICAL FIELD

The present invention relates to a sealed container and a sealed container set suitable for allowing a packaged substance housed in a clean condition to be taken out in a clean condition.

### BACKGROUND ART

In pharmaceutical tests, diagnoses, and treatments, it is important that instruments to be used and pharmaceuticals are not contaminated. For example, in such tests, liquid housed in a container in an endotoxin-free clean condition may be collected with a micropipette and used.

As the above-mentioned container, for example, a liquid container illustrated in FIGS. 1A and 1B has been known. Liquid container 10 includes container body 12 provided with liquid supply part 11, sealing sheet 14 disposed on frame 13 surrounding the opening of container body 12, evaporation prevention sheet 15 disposed on sealing sheet 14, and cover 17 that: is made of metal; has a plurality of through holes; and covers evaporation prevention sheet 15. Evaporation prevention sheet 15 has a plurality of cross-shaped slits at positions corresponding to through holes 16. Chip 20 of a micropipette is inserted from through hole 16 to press evaporation prevention sheet 15 to be bent by slit 18, and reaches liquid housed in container body 12. Thus, the liquid housed in container body 12 is collected into the micropipette (e.g., PTL 1).

### CITATION LIST

### Patent Literature

PTL 1

Japanese Patent Application Laid-Open No. 2007-263869

### SUMMARY OF INVENTION

### Technical Problem

Evaporation prevention sheet 15 has slits 18. Therefore, the inside of container body 12 is constantly in communication with the outside of liquid container 10 through slits 18. Accordingly, the inside of container body 12 is contaminated from the outside of container body 12 through slits 18, and as a result contaminated liquid may be collected. Thus, liquid container 10 has room for improvement in that a packaged substance housed in container body 12 in a clean condition is taken out from container body 12 in a clean condition.

A first object of the present invention is to provide a sealed container which enables a packaged substance housed in a container in a clean condition to be taken out from the container in a clean condition.

A second object of the present invention is to provide a sealed container set which is convenient for allowing the packaged substance to be taken out from the container in a clean condition.

### Solution to Problem

The present invention provides a sealed container including at least one container each having an opening, and a film adhered to the container to seal the opening, in which: the film includes a first film layer adhered to the container and a second film layer adhered to the first film layer; the first film layer has a first bendable lid part shaped by a first cut line at a portion corresponding to the opening, the first bendable lid part being bent toward the container when being pressed toward the container; the second film layer has a second bendable lid part shaped by a second cut line at a portion corresponding to the opening, the second bendable lid part being bent toward the container when being pressed toward the container; the first cut line and the second cut line do not overlap each other over the opening in a layered direction of the film; at least a part of the first bendable lid part and the second bendable lid part overlap each other in the layered direction; and both the second bendable lid part and the first bendable lid part are bent toward the container when the second bendable lid part is pressed toward the container.

Further, the present invention provides a sealed container set including the sealed container including a multi-chamber container in which a plurality of the containers are arranged in one direction, and a support frame for supporting the sealed container.

### Advantageous Effects of Invention

In the sealed container according to the present invention, a two-layer structured film is pressed toward the container from the outside of the film to thereby form an opening which communicates between the inside and the outside of the container, and a packaged substance inside the container is extracted through the opening, thereby allowing the packaged substance to be taken out from the container while being in contact with a clean portion of the film. Thus, the present invention enables a packaged substance housed in a container in a clean condition to be taken out in a clean condition. The sealed container set according to the present invention can support a plurality of the containers. Thus, according to the present invention, it becomes possible to provide a sealed container set convenient for allowing the packaged substance to be taken out in a clean condition from the container.

### BRIEF DESCRIPTION OF DRAWINGS

FIG. 1A is an exploded perspective view of a conventional liquid container, and FIG. 1B is a cross-sectional view schematically illustrating a structure of the liquid container when collecting liquid;

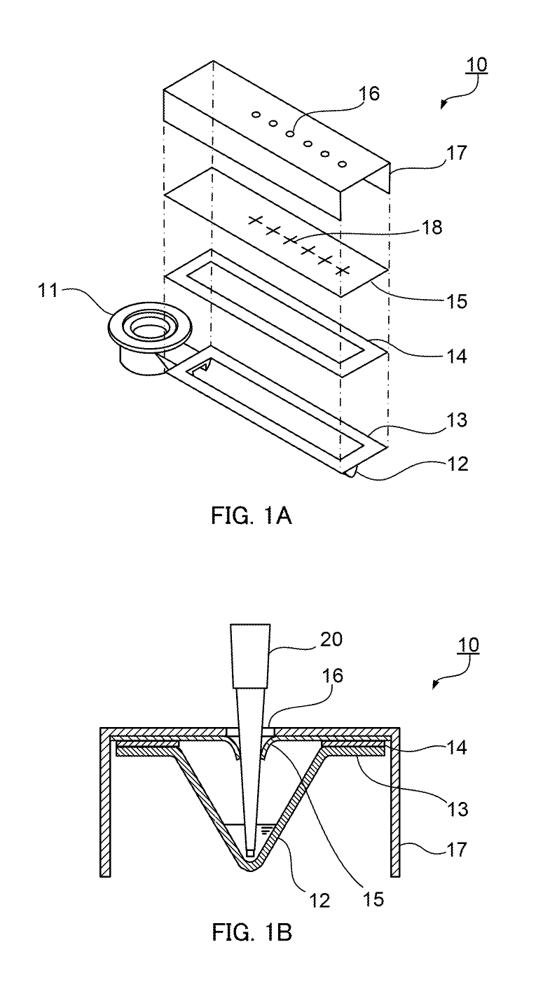

FIG. 2 is a perspective view of a sealed container set according an embodiment of the present invention;

FIG. 3A is a plan view of the sealed container set according an embodiment of the present invention, and FIG. 3B is a cross-sectional view of the sealed container set taken along line B-B in FIG. 3A;

FIG. 4 is a perspective view of a sealed container according an embodiment of the present invention;

FIG. 5A is a front view of the sealed container according to an embodiment of the present invention, FIG. 5B is a cross-sectional view of the sealed container taken along line B-B in FIG. 3A, and FIG. 5C is a plan view of the sealed container;

FIG. 6 is an enlarged view of portion C in FIG. 5B;

FIGS. 7A, 7B, and 7C are, respectively, a perspective view, a plan view, and a front view of a film according to an embodiment of the present invention;

FIG. 8A is an enlarged view of portion A in FIG. 7B, and FIG. 8B is a cross-sectional view of the film according to an embodiment of the present invention taken along line B-B in FIG. 8A;

FIG. 9A is a cross-sectional view schematically illustrating the film and a pipetter, with a second bendable lid part being slightly pressed by the pipetter, FIG. 9B is a cross-sectional view schematically illustrating the film and the pipetter, with the second bendable lid part being further pressed by the pipetter, FIG. 9C is a cross-sectional view schematically illustrating the film, the pipetter and a chip, with the pipetter entering the container and being attached to the chip inside the container, and FIG. 9D is a cross-sectional view schematically illustrating the film, and the chip, with the chip that is attached to the pipetter being taken out from the container;

FIG. 10A illustrates a modification of an engaging part, FIG. 10B is an enlarged plan view of a main part of a modification of a support frame which engages with the engaging part, and FIG. 10C is an enlarged side view of a main part of a modification of the support frame;

FIG. 11A, FIG. 11B, and FIG. 11C schematically illustrate, respectively, a first modification, a second modification, and a third modification of a first cut line and a second cut line in the present invention;

FIG. 12A and FIG. 12B schematically illustrate, respectively, a fourth modification and a fifth modification of a first cut line and a second cut line in the present invention; and

FIG. 13 is an enlarged view of a main part of a modification of a sealed container according to the present invention.

### DESCRIPTION OF EMBODIMENTS

In the following, embodiments of the present invention will be described in detail with reference to the accompanying drawings.

### Configuration

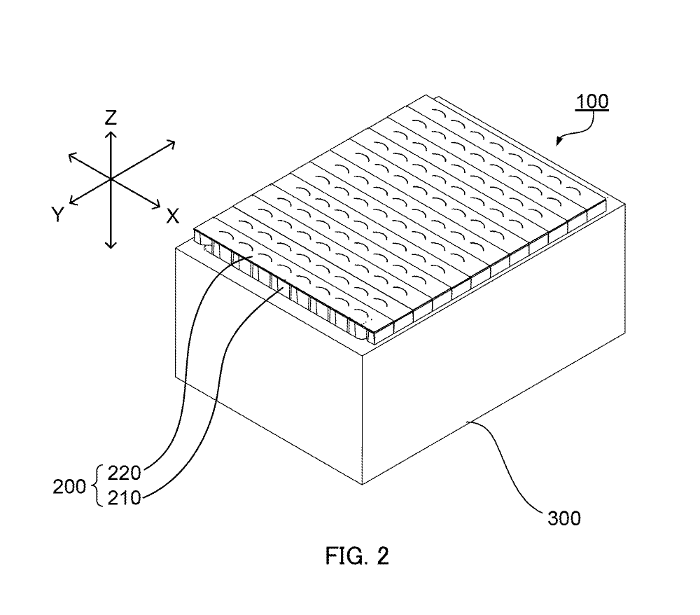

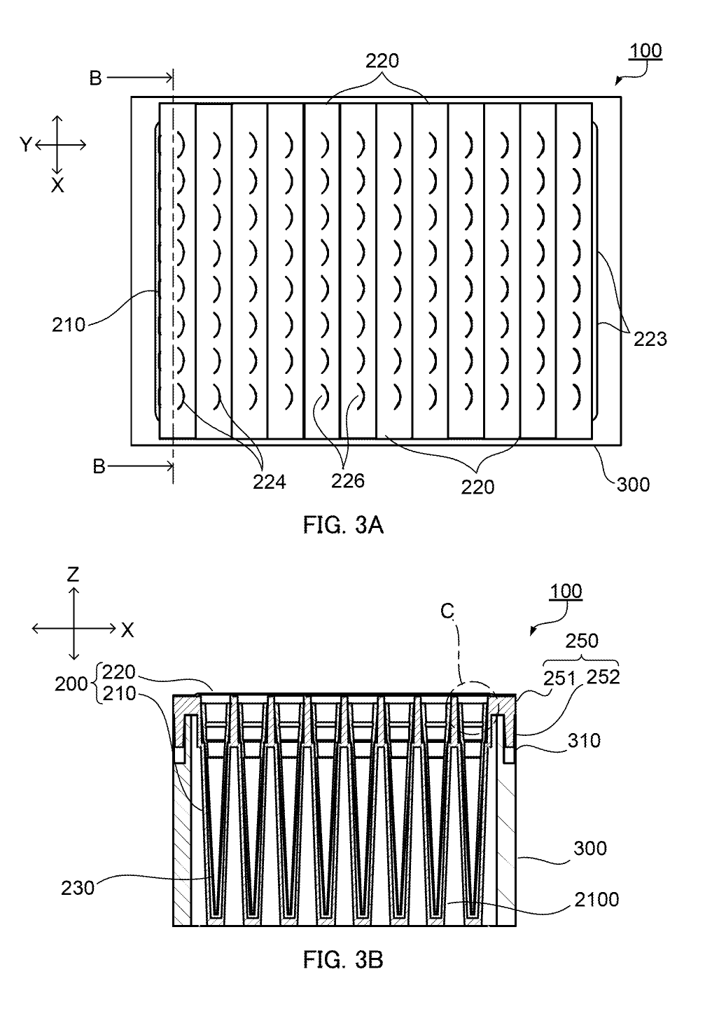

FIG. 2 is a perspective view of sealed container set 100 according a first embodiment of the present invention. FIG. 3A is a plan view of sealed container set 100, and FIG. 3B is a cross-sectional view of sealed container set 100 taken along line B-B in FIG. 3A. Sealed container set 100 includes sealed container 200 and support frame 300.

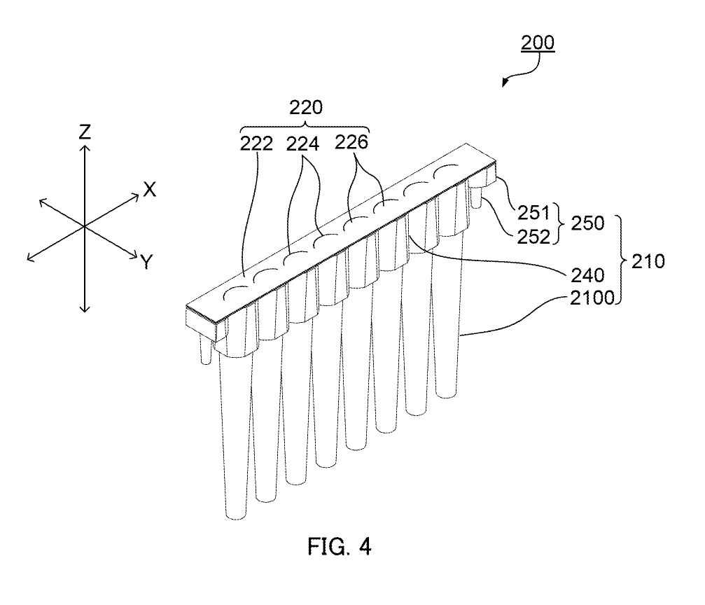

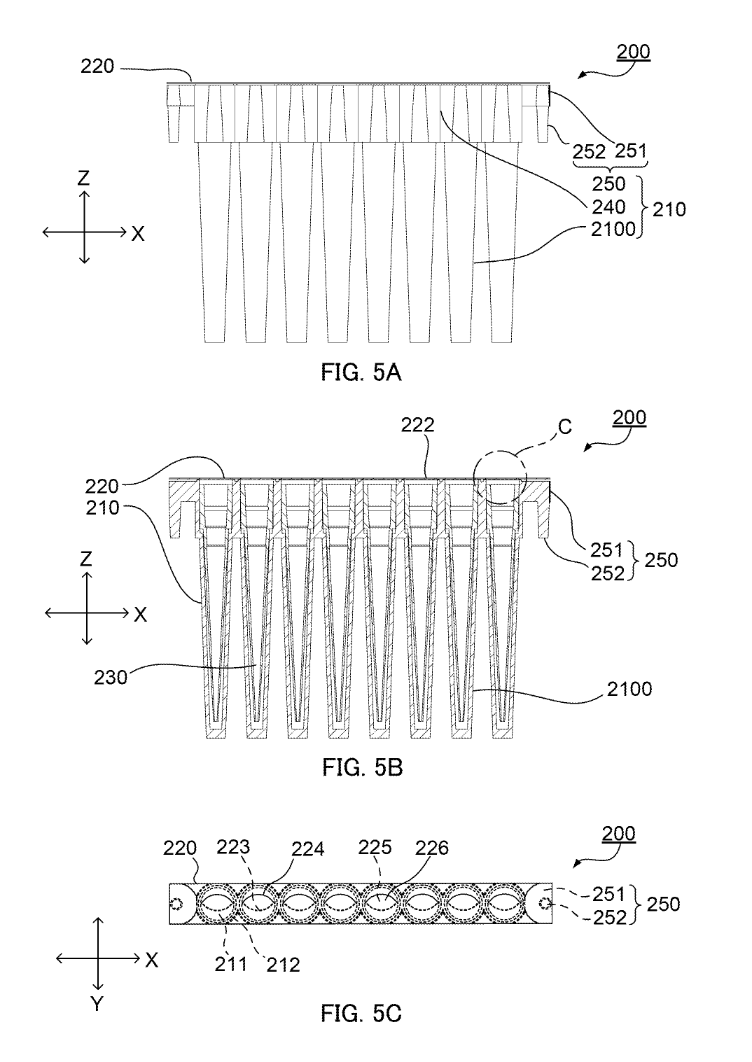

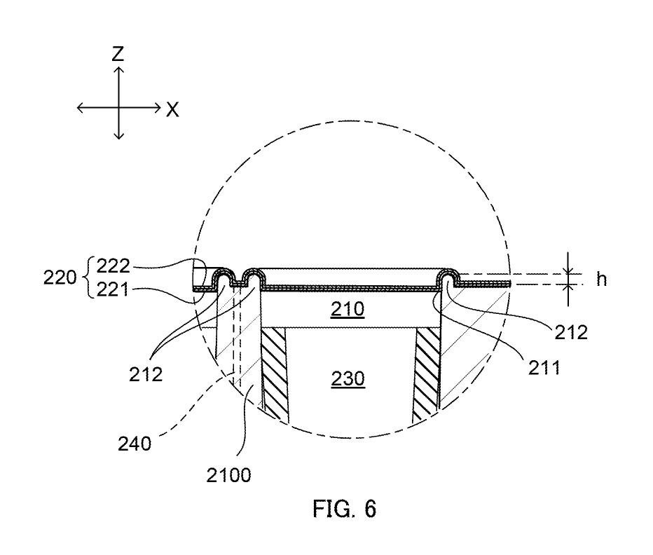

FIG. 4 is a perspective view of sealed container 200. FIG. 5A is a front view of sealed container 200, FIG. 5B is a cross-sectional view of sealed container 200 taken along line B-B in FIG. 3A, and FIG. 5C is a plan view of sealed container 200. FIG. 6 is an enlarged view of portion C in FIG. 5B. Sealed container 200 includes multi-chamber container 210 and film 220.

Multi-chamber container 210 includes eight containers 2100 arranged in a row in X direction (FIG. 4). Containers 2100 each have opening 211 (FIG. 5C). In multi-chamber container 210, containers 2100 are arranged such that openings 211 are arranged in a row in X direction.

Each container 2100 is a slender bottomed container, with Z direction perpendicular to X direction being depth direction. Each container 2100 houses chip 230 for a micropipette (FIG. 5B). Chip 230 is, for example, housed in each container 2100 in an endotoxin-free clean condition.

The shape of opening 211 can be set depending on the shape of a packaged substance housed in containers 2100, and is a circular shape, for example, when the packaged substance is chip 230. Multi-chamber container 210 further has protrusion 212 that protrudes toward film 220 in Z direction around opening 211 (FIG. 6). The shape of protrusion 212 in a plan view is a circular shape which is the same as the shape of opening 211. The protruded length of protrusion 212 in Z direction (h in FIG. 6) is, for example, 0.5 mm.

Multi-chamber container 210 further has breakable thin wall part 240 that connects containers 2100 which are adjacent to each other in X direction (FIGS. 5A and 6). Thin wall part 240 is a part between outer peripheral walls of adjacent containers 2100.

The length of thin wall part 240 in Z direction is 5.0 mm, and the length (width) of thin wall part 240 in Y direction perpendicular to X and Z directions is 0.5 mm, and the length (thickness) of thin wall part 240 in X direction is 0.5 mm.

Multi-chamber container 210 further has engaging parts 250 disposed at both ends of multi-chamber container 210 (FIG. 4). Engaging part 250 has protruding part 251 that further protrudes outward from the end of multi-chamber container 210 along X direction, and rod 252 that extends in a direction opposite to film 220 from protruding part 251 along Z direction.

Multi-chamber container 210 can be obtained, for example, by injection molding of resin. Examples of the resin include polyolefin resins, polyamide resins, polystyrene resins, methyl polymethacrylate resins, polycarbonates, and cycloolefin copolymer resins. Examples of the polyolefin resins include polypropylene resins such as homopolypropylene, random polypropylene, and block polypropylene; and polyethylene resins such as high-density polyethylene, and low-density polyethylene. Examples of the polyamide resins include nylon. Examples of the polystyrene resins include polystyrene in which a rubber component for reinforcement may be compounded.

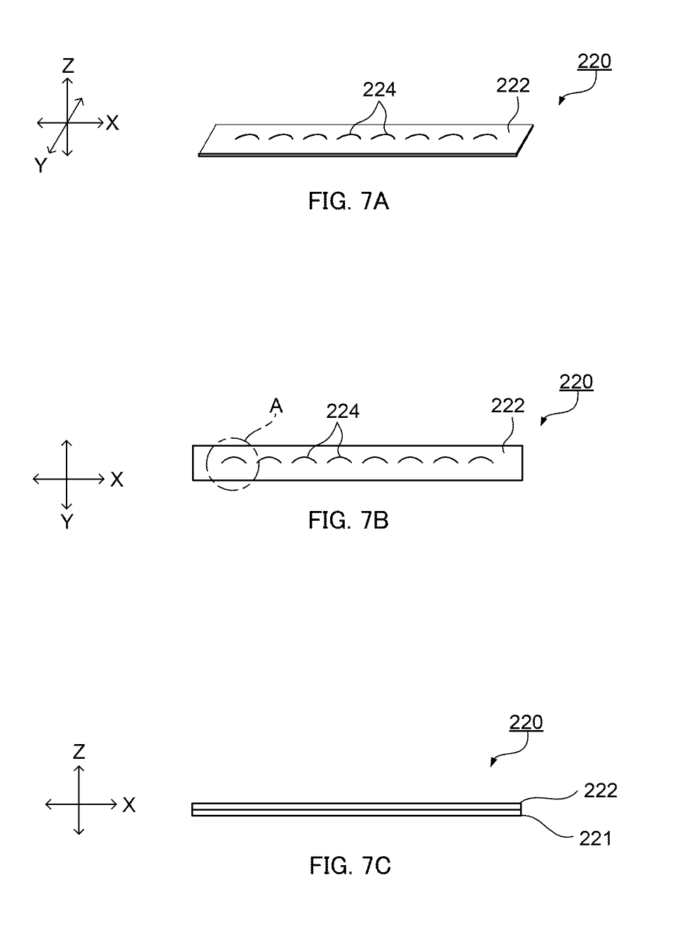

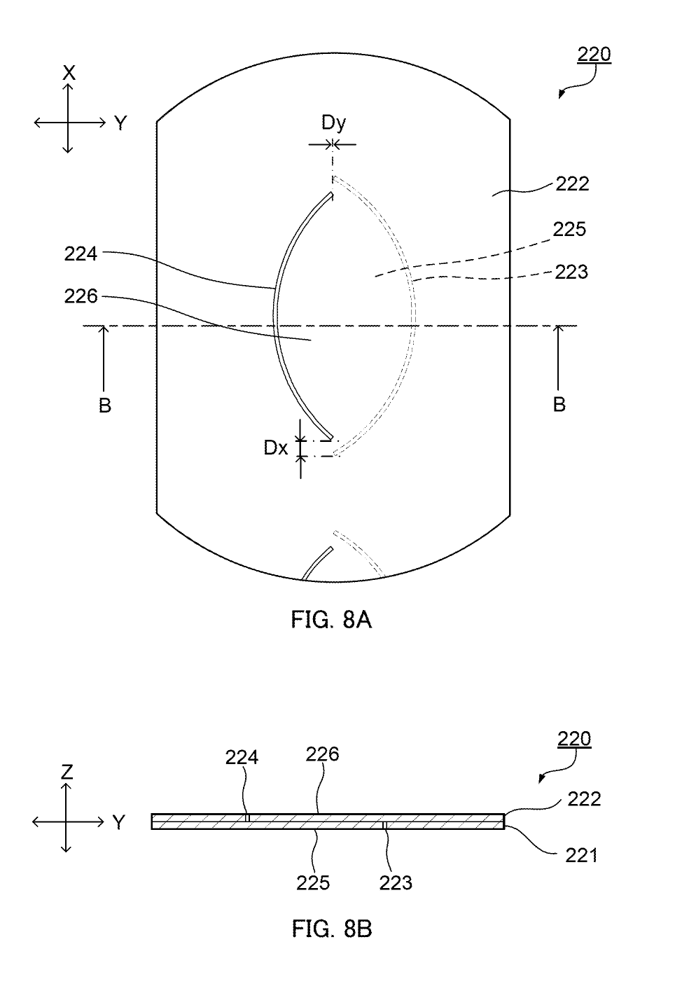

FIGS. 7A, 7B, and 7C are, respectively, a perspective view, a plan view, and a front view of film 220. FIG. 8A is an enlarged view of portion A in FIG. 7B, and FIG. 8B is a cross-sectional view of film 220 taken along line B-B in FIG. 8A.

Film 220 has first film layer 221 adhered to multi-chamber container 210, and second film layer 222 adhered to first film layer 221 (FIGS. 6 and 7C).

First film layer 221 has first bendable lid part 225 shaped by first cut line 223 at a portion corresponding to each of openings 211. Second film layer 222 has second bendable lid part 226 shaped by second cut line 224 at a portion corresponding to each of openings 211 (FIGS. 8A and 8B).

As illustrated in FIG. 5C and 8A, the shape of first cut line 223 is a curve convex toward one side in Y direction. Further, the shape of second cut line 224 is a curve convex toward the other side in Y direction. Z direction is a direction in which film 220 is layered. Y direction is a first direction perpendicular to Z direction. Note that X direction is a second direction crossing (in the present embodiment, perpendicular to) Y direction, and is also a direction in which openings 211 are arranged.

First cut line 223 and second cut line 224 do not overlap in Z direction. Further, the positions of both ends of first cut line 223 in X direction are outside the positions of both ends of second cut line 224 (FIG. 8A). Further, all of the positions of both ends of first cut line 223 and the positions of both ends of second cut line 224 in X direction are inside opening 211 in X direction (FIG. 5C).

Second bendable lid part 226 overlaps first bendable lid part 225 in Z direction (FIG. 8A). First bendable lid part 225 is a part, of first film layer 221, which is bent toward container 2100 when being pressed toward container 2100. Second bendable lid part 226 is a part, of second film layer 222, which is bent toward container 2100 when being pressed toward container 2100. For example, first bendable lid part 225 is a part, of first film layer 221, sandwiched by first cut line 223 and second cut line 224 when viewed in a plan view. For example, second bendable lid part 226 is a part, of second film layer 222, sandwiched by first cut line 223 and second cut line 224 when viewed in a plan view. Thus, film 220 is configured such that both second bendable lid part 226 and first bendable lid part 225 are bent toward container 2100 when second bendable lid part 226 is pressed toward container 2100.

Distance in X direction (Dx) from one end of first cut line 223 in X direction to one end of second cut line 224 in X direction (FIG. 8A) can be appropriately determined from such a range that: first cut line 223 and second cut line 224 do not overlap each other in Z direction; an opening of an intended size is formed when first bendable lid part 225 and second bendable lid part 226 are bent toward container 2100; and both first bendable lid part 225 and second bendable lid part 226 are bent toward container 2100 when second bendable lid part 226 is pressed toward container 2100. For example, distance Dx is −2 to 2 mm when a case where the position of one end of second cut line 224 is closer to the edge of opening 211 than the position of one end of first cut line 223 is set as positive.

Distance in Y direction (Dy) from one end of first cut line 223 in X direction to one end of second cut line 224 in X direction (FIG. 8A) can be appropriately determined from such a range that: first cut line 223 and second cut line 224 do not overlap each other in Z direction; and both first bendable lid part 225 and second bendable lid part 226 are bent toward container 2100 when second bendable lid part 226 is pressed toward container 2100. For example, distance Dy is preferably 0 mm or more.

The shortest distance in X-Y plane from one end of first cut line 223 or one end of second cut line 224 to the edge of opening 211 (distance in X direction in the present embodiment) can be appropriately determined from the intended size of the opening formed by the bending of second bendable lid part 226 and first bendable lid part 225 toward container 2100. The shortest distance is, for example, 7.0 to 10.0 mm from the viewpoint of taking out a packaged substance having substantially the same size as that of opening 211.

Both first film layer 221 and second film layer 222 are obtained, for example, by cutting a film made of resin. Examples of the resin include polyester resins, polyolefin resins, polyamide resins, polycarbonates, ethylene copolymer, and combinations thereof. Examples of the polyester resins include polyethylene terephthalate and polyethylene naphthalate. Examples of the polyolefin resins include high-density polypropylene, low-density polyethylene, linear low-density ethylene-a-olefin copolymer, homopolypropylene, and random copolymer polypropylene formed by polymerized monomers including ethylene and propylene. The ethylene copolymer is a copolymer formed by polymerized monomers including ethylene and (meth)acrylic acid alkyl ester or vinyl ester. First film layer 221 and second film layer 222 may contain a material other than a resin, such as a layered product of metal foil and a resin-made film, in such a range that first film layer 221 and second film layer 222 can function properly.

The thickness of first film layer 221 and second film layer 222 can be appropriately determined in such a range that first bendable lid part 225 and second bendable lid part 226 can achieve intended functions, respectively. For example, the thickness of first film layer 221 and second film layer 22 is 10 to 200 μm, respectively.

Film 220 can be configured by forming first cut line 223 on first film layer 221 and forming second cut line 224 on second film layer 222 by half-cutting each of first and second film layers 221 and 222, which are weakly adhered to each other, of two-layer structured film (easy-peel film).

The adhesion of film 220 to an end face, on the side of opening 211, of multi-chamber container 210 is performed, for example, by thermal fusion. By pressing film 220 toward multi-chamber container 210, for example, with a suitable force using an elastic body made of a silicone rubber during the thermal fusion of film 220, it becomes possible to adhere film 220 to multi-chamber container 210 as well as to the peripheral wall surface of protrusion 212.

Support frame 300 is a frame which is rectangular when viewed in a plan view, as illustrated in FIGS. 2, 3A, and 3B. Support frame 300 has twelve holes 310 on one end face, in Z direction, of each of pairs of long side portions along Y direction. Hole 310 has a size that allows rod 252 to be inserted therein. The material for support frame 300 is not limited. Support frame 300 can be obtained, for example, by resin molding. Examples of the resin include polyolefin resins, polyamide resins, polystyrene resins, methyl polymethacrylate resins, polycarbonates, and cycloolefin copolymer resins.

### Action

Each rod 252 of engaging parts 250 at both ends of sealed container 200 is inserted into each of pairs of holes 310 disposed at corresponding positions in the pairs of long side portions of support frame 300. This insertion allows engaging part 250 to be engaged with support frame 300 detachably, so that sealed container 200 is supported by support frame 300, with opening 211 facing one side in Z direction (FIG. 3B).

For example, when twelve pairs of holes 310 of support frame 300 support twelve sealed containers 200 therein, with the center-to-center distance of opening 211 in X direction being set at 9 mm and the center-to-center distance of hole 310 of support frame 300 in Y direction being set at 9 mm, the position of openings 211 of twelve sealed containers 200 supported by support frame 300 is the same as the arrangement of wells in a 96-well microplate (FIGS. 2 A and 3A).

First bendable lid part 225 and second bendable lid part 226 usually overlap each other. In addition, first cut line 223 and second cut line 224 do not overlap each other in Z direction. Accordingly, opening 211 is usually sealed by film 220. Chip 230 housed in each container 2100 is usually kept in an endotoxin-free clean condition. Chip 230 is, for example, taken out as follows.

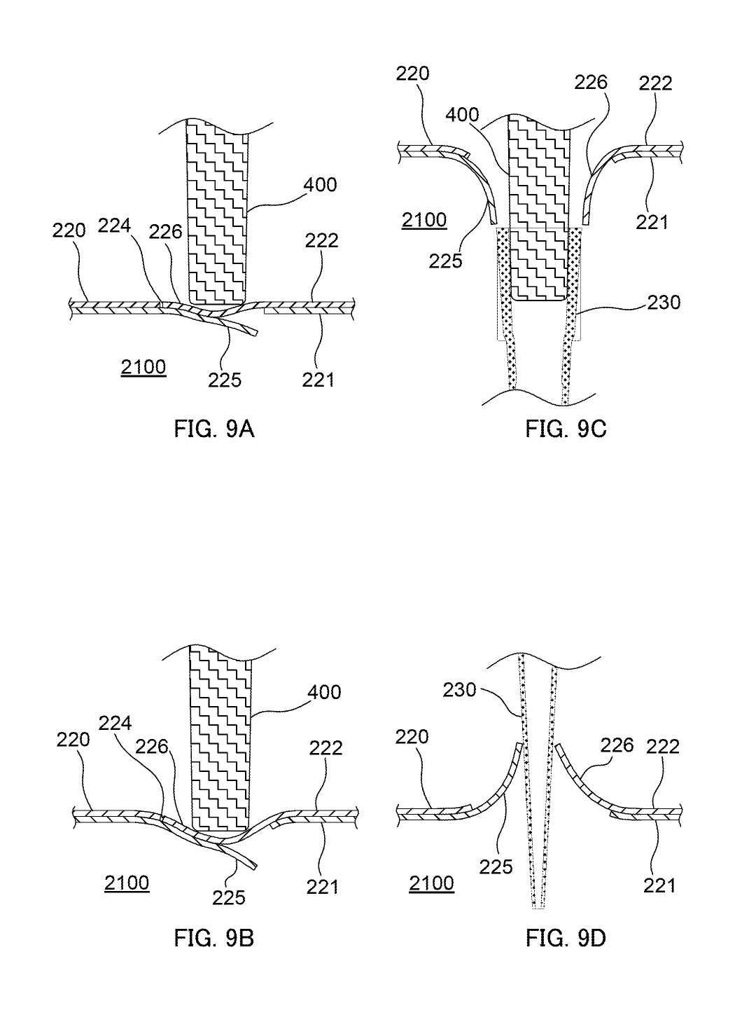

FIG. 9A is a cross-sectional view schematically illustrating film 220 and pipetter 400, with second bendable lid part 226 being slightly pressed by pipetter 400, and FIG. 9B is a cross-sectional view schematically illustrating film 220 and pipetter 400, with second bendable lid part 226 being further pressed by pipetter 400.

When second bendable lid part 226 is pressed by the tip of pipetter 400, second bendable lid part 226 starts to be bent toward container 2100. As second bendable lid part 226 starts to be bent, first bendable lid part 226 is bent toward container 2100 while being peeled off from second bendable lid part 226. When first bendable lid part 225 is peeled off from second bendable lid part 226 and first and second bendable lid parts 225 and 226 are bent together toward container 2100, an opening is formed on second film layer 222, with second cut line 224 being a part of the end edge of the opening, and an opening is formed on first film layer 221, with first cut line 223 being a part of the end edge of the opening. Thus, pipetter 400 is inserted into container 2100 through the opening formed in each of first and second film layers 221 and 222.

FIG. 9C is a cross-sectional view schematically illustrating film 220, pipetter 400 and chip 230, with pipetter 400 being inserted into container 2100 and being attached to chip 230 inside container 2100. When chip 230 is attached to pipetter 400, pipetter 400 is extracted.

It is possible that, when the surface of second film layer 222 is contaminated with endotoxin, a portion, at the tip of pipetter 400, which contacts with second bendable lid part 226 may also be contaminated. However, liquid to be sucked into chip 230 when using chip 230 does not usually contact with pipetter 400. Accordingly, chip 230 is attached to pipetter 400 in a substantially non-contaminated clean condition, regardless of the presence/absence of the contamination of pipetter 400.

FIG. 9D is a cross-sectional view schematically illustrating film 220 and chip 230, with chip 230 that is attached to pipetter 400 being taken out from container 2100. Each of second and first bendable lid parts 226 and 225 bent toward containers 2100 contacts with inserted pipetter 400. That is, the surfaces of second and first film layers 222 and 221 abut pipetter 400.

When extracting pipetter 400 from container 2100, both first and second bendable lid parts 225 and 226 contact with pipetter 400. Then, the friction thereof with pipetter 400 or the abutment of the tips of first and second bendable lid parts 225 and 226 with the base end of chip 230 allows first and second bendable lid parts 225 and 226 to be reversed in association with the extraction of pipetter 400.

Chip 230 attached to the tip of pipetter 400 contacts with reversed first and second bendable lid parts 225 and 226 when extracting pipetter 400. That is, chip 230 contacts with clean rear surfaces of first and second bendable lid parts 225 and 226 when extracting pipetter 400.

Accordingly, chip 230 is taken out from each container 2100 in a clean condition without being contaminated with endotoxin. Chip 230 taken out in a clean condition is already attached to pipetter 400, and is thus used as in the clean condition. Thus, sealed container 200 according to the present embodiment is suitable for allowing a solid material housed in a clean condition supported at the tip of a member inserted into each container 2100 from the outside of film 220 to be taken out in a clean condition.

Sealed container 200 is supported by support frame 300, and thus chip 230 is attached to all the tips of eight consecutive pipetters as described above when the eight consecutive pipetters are inserted into all of eight consecutive containers 2100.

When film 220 is cut along Y direction immediately above thin wall part 240 to break thin wall part 240, a separate sealed container, i.e., single container 2100 sealed with a single lid made of a film including first bendable lid part 225 and second bendable lid part 226 is obtained.

### Effect

Sealed container set 100 includes sealed container 200 and support frame 300, as described above. Accordingly, it is possible to handle sealed container 200 with opening 211 of each container 2100 facing upward, and thus it is convenient to take out chip 230 in a clean condition from each container 2100.

Sealed container 200 includes containers 2100 each having opening 211, and film 220 adhered to containers 2100 to seal opening 211, as described above. Each container 2100 houses chip 230, and film 220 includes first film layer 221 adhered to containers 2100 and second film layer 222 adhered to first film layer 221. First film layer 221 has first bendable lid part 225 which is shaped by first cut line 223 at a portion corresponding to opening 211 and which is bent toward container 2100 when being pressed toward container 2100, and second film layer 222 has second bendable lid part 226 which is shaped by second cut line 224 at a portion corresponding to opening 211 and which is bent toward container 2100 when being pressed toward container 2100. Further, first cut line 223 and second cut line 224 do not overlap over opening 211 in Z direction, and at least a part of first bendable lid part 225 overlaps second bendable lid part 226 in Z direction. Both second and first bendable lid parts 226 and 225 are bent toward container 2100 when second bendable lid part 226 is pressed toward container 2100. Due to the friction with pipetter 400, the abutment with the end portion of chip 230, or other causes, first and second bendable lid parts 225 and 226 are, for example, dragged and reversed in association with the extraction of pipetter 400. Accordingly, even when chip 230 taken out from each container 2100 contacts with first and second bendable lid parts 225 and 226, chip 230 contacts only with clean surfaces, i.e., rear surfaces of first and second bendable lid parts 225 and 226. Therefore, according to sealed container 200, chip 230 housed in each container 2100 in a clean condition can be taken out from each container 2100 in a clean condition.

It is more effective that first bendable lid part 225 is shaped by first cut line 223 in such a shape as to protrude toward one side in Y direction and second bendable lid part 226 is shaped by second cut line 224 in such a shape as to protrude toward the other side in Y direction, from the viewpoint of forming in film 220 an opening of a size closer to that of opening 211.

It is more effective for the positions of both ends of first cut line 223 in X direction to be outside the positions of both ends of second cut line 224, from the viewpoints of disposing first and second cut lines 223 and 224 so as not to overlap in Z direction, and of forming a larger opening in film 220 in Y direction.

By positioning all of both ends of first cut line 223 and both ends of second cut line 224 in X direction inside opening 211 in X direction, it becomes possible to employ the entire part of a virtual line connecting both ends of first cut line 223 as a base end portion along which first bendable lid part 225 is bent and the entire part of a virtual line connecting both ends of second cut line 224 as a base end portion along which second bendable lid part 226 is bent, respectively. Accordingly, it is more effective for first and second cut lines 223 and 224 to be in the above-described positional relationship, from the viewpoint of forming an opening in film 220 more easily than a case where the first and second cut lines extend outside of opening 211.

It is more effective that containers 2100 constitute multi-chamber container 210 in which eight containers 2100 are arranged in one direction, and that film 220 integrally seals all openings 211 of multi-chamber container 210, from the viewpoints of further enhancing the productivity of sealed container 200 compared to a case where containers 2100 are sealed separately with a film, and of significantly reducing the risk of contamination in the production process of sealed container 200.

It is more effective that multi-chamber container 210 further has breakable thin wall part 240 connecting containers 2100 which are adjacent to each other, from the viewpoint of allowing eight consecutive sealed containers to be separately available.

It is more effective that multi-chamber container 210 further has engaging part 250, disposed at both ends of multi-chamber container 210, for engaging with support frame 300, from the viewpoint of enhancing the convenience of taking out chip 230 in a clean condition from each container 2100.

It is more effective for multi-chamber container 210 to further has protrusion 212 around each opening 211, from the viewpoint of further enhancing the adhesive strength of film 220 with respect to multi-chamber container 210 due to an enlarged area for adhesion between film 220 and multi-chamber container 210 compared to a case where multi-chamber container 210 does not have protrusion 212.

### Modification

Moreover, the embodiment of the present invention may include a further modification in such a range as to enable the effects of the present invention to be achieved.

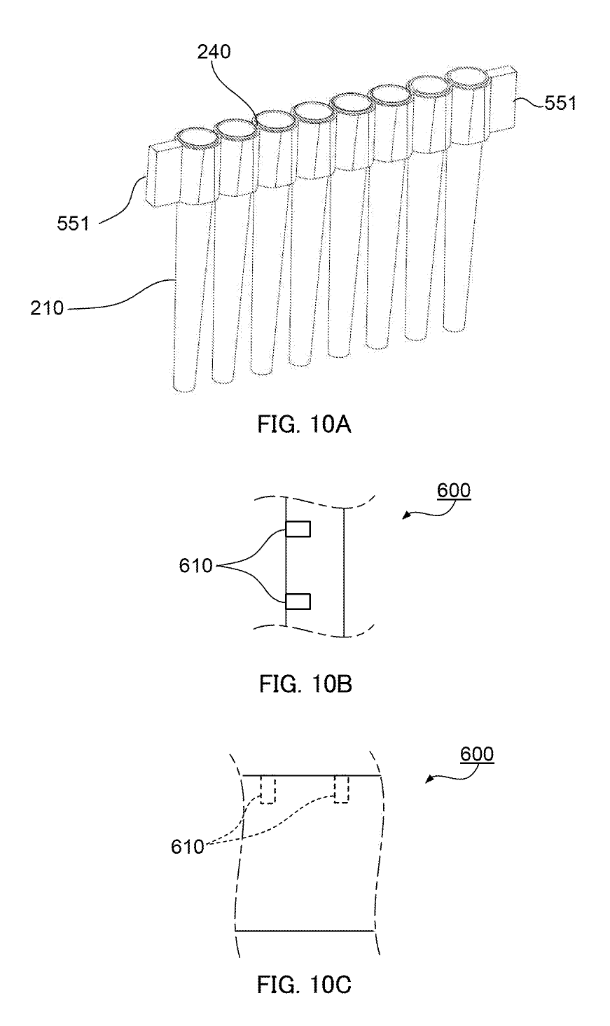

For example, an engaging part illustrated in FIG. 10A is composed of quadrangular prism-shaped protruding part 551 that protrudes in X direction. Further, support frame 600 illustrated in FIGS. 10B and 10C has recess parts 610 cut out in a quadrangular prism shape in one end portion of the inner wall surface of support frame 600. Protruding part 551 is fit into recess 610. Thus, the engagement of the sealed container with the support frame can adopt various modes such as a mode in which a rod is inserted into a hole, or a mode in which a convex part is fitted into a recess part.

In the above-described embodiment, while both the ends of the first cut line are outside both the ends of the second cut line in the arrangement direction of the openings, it is also possible to adopt a reverse configuration, i.e., to position both the ends of the second cut line to be outside both the ends of the first cut line in the arrangement direction of the openings. This configuration also achieves the same effects of the above-described configuration in which both ends of the first cut line are outside both ends of the second cut line.

The first and second cut lines may be either the above-mentioned portions which cut the film, or structures to cut the film when the second bendable lid part is pressed toward the container, for example, a break line such as perforation, and a half cut line such as a half-cut part.

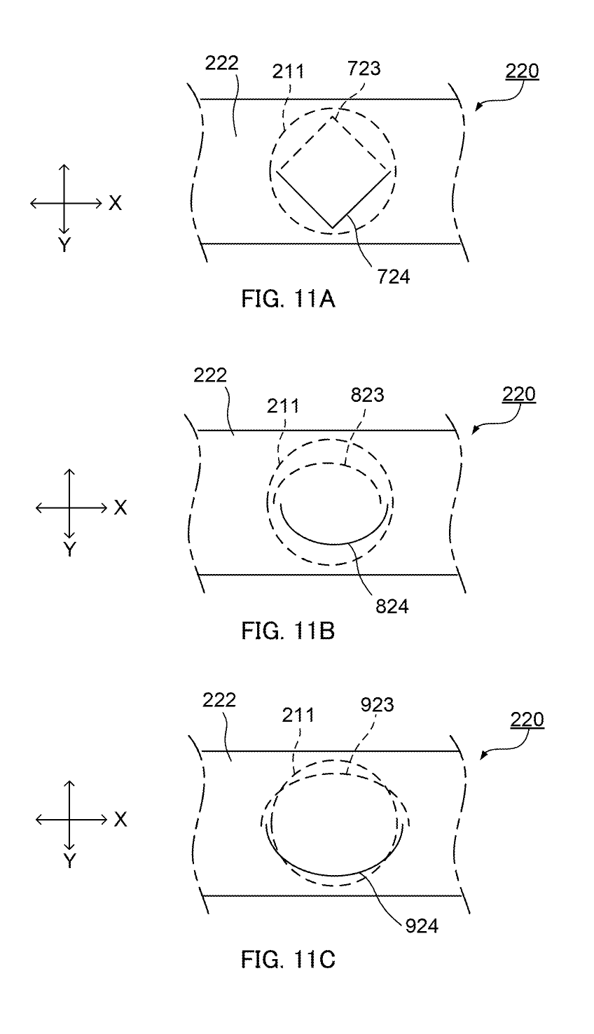

The shapes of the first and second cut lines in a plan view do not need to be curved. For example, as illustrated in FIG. 11A, the shapes of first cut line 723 and second cut line 724 both may be shapes composed of two straight lines forming an angle therebetween.

Both ends of one of the first and second cut lines do not need to be positioned outside both ends of the other. For example, as illustrated in FIG. 11B, one end and the other end of first cut line 823 may be positioned in a manner to be shifted toward one side in X direction away from one end and other end of second cut line 824, respectively.

Both ends of the first and second cut lines do not need to be positioned inside opening 211 in X direction. For example, as illustrated in FIG. 11C, both ends of first cut line 923 and both ends of second cut line 924 may be both positioned outside opening 211 in X direction.

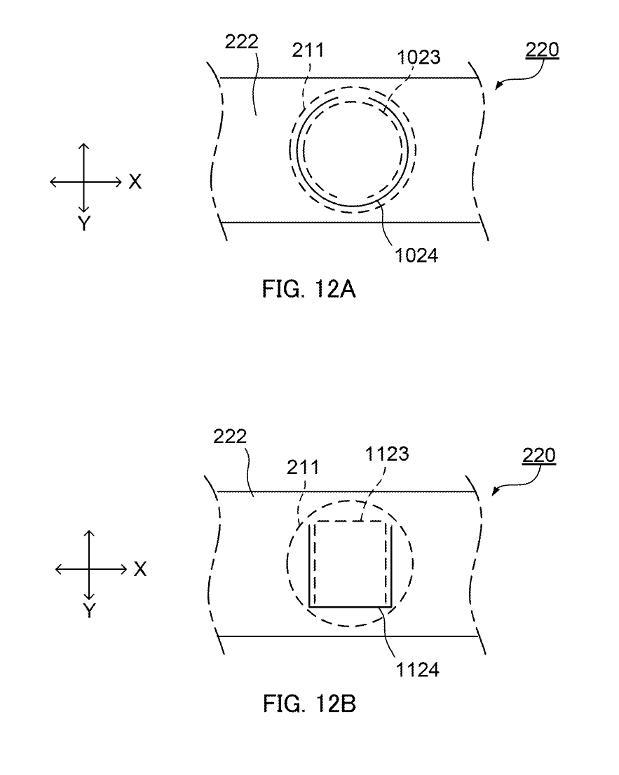

The first and second cut lines both may be disposed over opening 211, and the second cut line may surround the first cut line. For example, as illustrated in FIG. 12A, first cut line 1023 may be formed into a circular arc shape, and second cut line 1024 may be formed into a circular arc shape which is outside first cut line 1023, the circular arc shape of second cut line 1024 having a larger diameter than that of first cut line 1023. Thus, it is more effective for first cut line 1023 to be surrounded by second cut line 1024 from the viewpoint of forming a large opening of an intended shape in film 220, because it becomes possible to form in film 220 an opening of substantially the same shape as that of the first bendable lid part.

As illustrated in FIG. 12B, the first bendable lid part may substantially overlap the second bendable lid part. Both the planar shapes of the first and second bendable lid parts are rectangular, and both the planar shapes of first cut line 1123 and second cut line 1124 are shapes each composed of three sides of the rectangle. Two opposite sides of the three sides of each of first and second cut lines 1123 and 1124 are both parallel to Y direction, and one sides between the opposite sides thereof are parallel to X direction. The one side therebetween of first cut line 1123 is positioned slightly outside both ends of second cut lien 1124, but the two opposite sides of first cut line 1123 are positioned inside second cut line 1124. Thus, even when second cut line 1124 is positioned outside first cut line 1123 at least in X direction, the first and second bendable lid parts substantially overlap each other, so that it becomes possible to form in film 220 an opening of substantially the same shape as that of the first bendable lid part. Therefore, in the present invention, even when one smaller bendable lid part overlaps the other larger bendable lid part in most part of the other bendable lid part (e.g., 90% or more), it can be said that the cut line of the other bendable lid part “surrounds” the cut line of one bendable lid part. Accordingly, the modification as described above is more effective from the viewpoint of forming a larger opening of an intended shape in film 220.

While FIGS. 12A and 12B illustrate embodiments in which the outer second bendable lid parts are larger than the inner first bendable lid part, the first bendable lid part may be larger than the second bendable lid part. Further, the direction in which the first bendable lid part is bent and the direction in which the second bendable lid part is bent may be orthogonal to each other, as in the case where the first bendable lid part is bent in X direction while second bendable lid part is bent in Y direction.

While, in the above-described embodiment, the planar shape of each of the first and second cut lines is the shape of an arc having a chord along X direction, the orientation of the chord either may be in Y direction perpendicular to X direction, instead of X direction; or may be in W direction which is oblique both to X and Y directions. Further, the orientation of the chord either may be the same for all the cut lines or may be different.

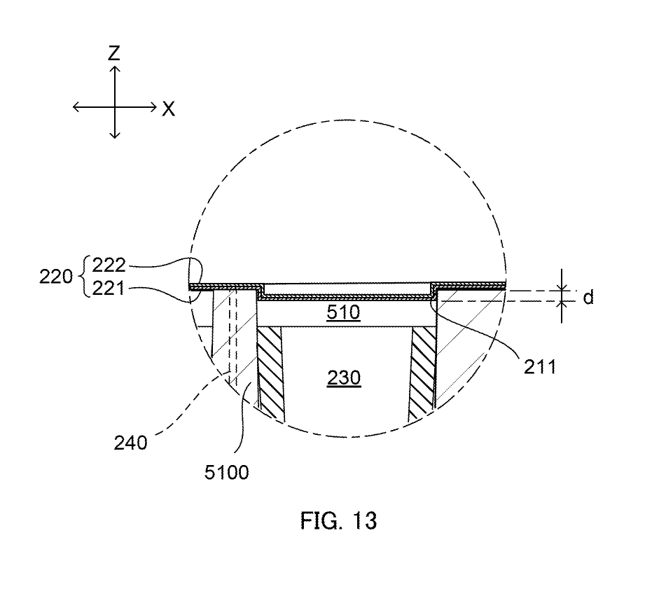

For example, as illustrated in FIG. 13, it is also possible for multi-chamber container 510 not to have the above-described protrusion, and for film 220 to be adhered to the end face of multi-chamber container 510 on opening 211 side and the end portion of the inner peripheral wall of container 5100 on opening 211 side to seal opening 211. The length in Z direction of film 220 adhered to the end portion of the inner peripheral wall portion of container 5100 on opening 211 side (i.e., distance in Z direction of the inner peripheral wall portion to which film 220 is adhered, from opening 211; d in FIG. 13) is, for example, 0.5 to 1.0 mm. Film 220 can be adhered to multi-chamber container 510 as described above, for example, by pressing film 220 toward multi-chamber container 510 with a suitable force using a heat-resistant elastic body such as a silicone rubber-made elastic body during the thermal fusion of film 220.

As described above, by adhering film 220 to the inner peripheral wall end portion of container 5100, it becomes possible to adhere film 220 to multi-chamber container 510 with sufficient adhesion area, even when multi-chamber container 510 does not have the protrusion. Thus, it is more effective for film 220 to be adhered to the end face of multi-chamber container 510 on opening 211 side and the end portion of the inner peripheral wall of container 5100 on opening 211 side to seal opening 211, from the viewpoint of enhancing the adhesive strength of film 220 with respect to multi-chamber container 510.

Containers 2100 and 5100 may be empty. Even when containers 2100 and 5100 are empty, it is possible to use opened containers 2100 and 5100 as endotoxin-free clean instruments.

At least a part of the surface of the first or second bendable lid part may be composed of a resin material that exhibits strong frictional force such as rubber. This configuration is advantageous from the viewpoint of surely reversing the first and second bendable lid parts when taking out a packaged substance from the container.

The film may further have a break line in the film at a position between the openings. Such a configuration is more convenient for dividing the containers into separate containers, since the film can also be teared when the thin wall part is broken.

The support frame either may be bottomed, or may further has a lid. Further, the above-described shape of the break line either may be a straight line, or may be a non-straight line including a curved portion.

Note that film 220 does not need to be an easy-peel film. For example, film 220 can also be formed by overlapping a film for first film layer 221 having preformed first cut line 223 and a film for second film layer 222 having preformed second cut line 224 and by thermally fusing both the films directly to the end face of multi-chamber container 210 on opening 211 side.

While a mode including multi-chamber container 210 in which eight containers 2100 are arranged in a row is described above as an embodiment of the present invention, it is also possible to compose the sealed container according to the present invention of container 2100 and a portion of film 220 corresponding to opening 211. Further, the configuration of the multi-chamber container is not limited to the configuration in which containers are arranged in a row, and the multi-chamber container may be configured such that the containers are arranged in multiple rows, or such that the openings are collected toward one side in Z direction (e.g., collected in a bundle).

This application is entitled to and claims the benefit of Japanese Patent Application No. 2013-239764 filed on Nov. 20, 2013, the disclosure of which including the specification, drawings and abstract is incorporated herein by reference in its entirety.

### INDUSTRIAL APPLICABILITY

The sealed container according to the present invention enables a packaged substance housed in a container in a clean condition to be taken out from the container in the clean condition. The sealed container and the sealed container set according to the present invention are expected to be applied to technical fields where contamination by endotoxin is not permitted, such as medical tests and experiments, and pharmaceutical preparations to contribute to the further progress of the technical fields.

### REFERENCE SIGNS LIST

10 Liquid container
11 Liquid supply part
12 Container body
13 Frame
14 Sealing sheet
15 Evaporation prevention sheet
16 Through hole
17 Cover
18 Slit
20 Chip
100 Sealed container set
200 Sealed container
210, 510 Multi-chamber container
211 Opening
212 Protrusion
220 Film
221 First film layer
222 Second film layer
223, 723, 823, 923, 1023, 1123 First cut line
224, 724, 824, 924, 1024, 1124 Second cut line
225 First bendable lid part
226 Second bendable lid part
230 Chip
240 Thin wall part
250 Engaging part
251, 551 Protruding part
252 Rod
300, 600 Support frame
310 Hole
400 Pipetter
610 Recess part
2100, 5100 Container

1. A sealed container comprising:
at least one container having an opening; and
a film adhered to the container to seal the opening,
wherein:
the film includes a first film layer adhered to the container and a second film layer adhered to the first film layer,
the first film layer has a first bendable lid part shaped by a first cut line at a portion corresponding to the opening, the first bendable lid part being bent toward the container when being pressed toward the container,
the second film layer has a second bendable lid part shaped by a second cut line at a portion corresponding to the opening, the second bendable lid part being bent toward the container when being pressed toward the container,
the first cut line and the second cut line do not overlap each other over the opening in a layered direction of the film,
at least a part of the first bendable lid part and the second bendable lid part overlap each other in the layered direction, and
both the second bendable lid part and the first bendable lid part are bent toward the container when the second bendable lid part is pressed toward the container.

2. The sealed container according to claim 1, wherein:
the first bendable lid part is shaped by the first cut line in such a shape as to protrude toward one side in a first direction perpendicular to the layered direction, and
the second bendable lid part is shaped by the second cut line in such a shape as to protrude toward the other side in the first direction.

3. The sealed container according to claim 1, wherein:
the first cut line and the second cut line are both disposed over the opening, and
one of the first cut line and the second cut line surrounds the other of the first cut line and the second cut line.

4. The sealed container according to claim 1, wherein:
the container houses a packaged substance.

5. The sealed container according to claim 1, wherein:
the sealed container comprises a plurality of the containers constituting a multi-chamber container in which the containers are arranged in one direction, and
the film integrally seals every opening of the containers constituting the multi-chamber container.

6. The sealed container according to claim 5, wherein the multi-chamber container further has a breakable thin wall part connecting the containers which are adjacent to each other.

7. The sealed container according to claim 5, wherein the multi-chamber container further has an engaging part, disposed at both ends of the multi-chamber container, for engaging with a support frame for supporting the sealed container.

8. A sealed container set comprising the sealed container according to claim 7 and the support frame.
